(19) United States
(12) Patent Application Publication
(10) Pub. No.: US 2014/0122573 A1
(43) Pub. Date: May 1, 2014

(54) METHOD AND SYSTEM FOR PROCESSING DATA THROUGH NETWORK

(71) Applicant: MIIICASA TAIWAN INC., Taipei (TW)

(72) Inventors: Min-Hui Wu, Taipei (TW); Yu-Sheng Lin, Taipei (TW)

(73) Assignee: MIIICASA TAIWAN INC., Taipei (TW)

(21) Appl. No.: 13/666,822

(22) Filed: Nov. 1, 2012

(51) Int. Cl. G06F 15/16

(52) U.S. Cl. 709/203

(57) ABSTRACT

The invention provides a method and system for processing, through a computer network, data in a storage or received from an input device. The user may send a data processing request from a client device to a server in a wide area network, and receive a first webpage having a data requesting module and data processing module. Through the data requesting module, the client device may send a data request to a network device having a storage or to a networked input device in a local area network. Moreover, once the client device receives the data, the client device may generate a second webpage having the data and the data processing module. Therefore, by adding the data processing module to the server, the user may request these processing modules and use the corresponding data processing function without manually updating the software or the firmware in the storage or client device.

### TECHNICAL FIELD

The present invention relates generally to processing data in a storage device through a network, and more specifically, to processing data in a storage device through a cloud service provided by a server.

### BACKGROUND OF THE INVENTION

With the development of the cloud computing service, new cloud services emerge along the way. In the meantime, to ensure information security, users tend to store important data, such as photo, music, video or document, in private storage devices. Moreover, users tend to use the functions or services provided by such storage devices to process the important data.

However, in traditional storage devices, such as the network-attached storage (NAS), functions or services are generally stored in the form of embedded storage in the firmware therein. As a result, users need to update such firmware to acquire new functions or services. Users may need more than ordinary knowledge to conduct the update. Moreover, the storage device may become inoperable if the update process fails or is not fully performed.

Therefore, there is a need in the art for a system to process the data in a storage device, and to provide new function or services to the storage device without updating the firmware therein.

### SUMMARY OF THE INVENTION

In one embodiment, a system having a client device and a network device connected to the client device and a server, for processing data through a network is provided. A data is stored in an internal or external storage device of the network device. A data processing module for processing such data is stored in the server. When the data and the data processing module are transmitted to the client device, the user at the client device is enabled to use the data processing module to process the data. That is, data processing functions may be provided to the user of the client device by the transmission of the data processing module. Therefore, if a new data processing function is to be provided to the client device, such function addition may be achieved by the server transmitting a new data processing module to the client device, instead of requiring the user to manually update the firmware of the client device. Similarly, if a data processing function of the client device is to be modified or deleted, such function modification or deletion may be achieved by the server transmitting a new data processing module to the client device, instead of requiring the user to manually update the firmware of the client device.

In another embodiment, a data of the user is stored in an external storage device of a network device, which is in a same local area network as the client device. The user at the client device may through a web browser request a cloud service from the server through the Internet. In response, the server transmits a webpage to the client device. The webpage may include a data requesting module for requesting data from the network device, and a data processing module, such as a photo editor, a music player, a video player or a document editor, for processing the data received. The data requesting module and the data processing module may be embedded into a HTML webpage implemented by program languages such as DHTML, JavaScript or ActionScript. The web browser at the client device executes the data requesting module to request data from the network device, and executes the data processing module to process such data, such as music play, document modification or photo sharing. As a result, new data processing functions of the server may be provided to the network device or the storage device through the transmission of data processing modules from the server to the network device or the storage device without having users to update the firmware thereof manually.

In yet another embodiment, a user at the client device may process the data continuously receiving from a networked input device in a local area network through the Internet. The networked input device may be a TV setup box, an internet radio or a network TV, and the data may be TV or radio channels. After receiving an application service request from the client device, the server transmits, in the form of a webpage, a data requesting module for requesting data from the networked input device and a data processing module for processing such data to the client device. When the user at the client device uses a web browser to execute the data requesting module, the client device may request a continuous reception of data from the networked input device, and process the data through the data processing module, such as music play, video play or channel selection.

It should be understood, however, that this Summary may not contain all aspects and embodiments of the present invention, that this Summary is not meant to be limiting or restrictive in any manner, and that the invention as disclosed herein will be understood by one of ordinary skill in the art to encompass obvious improvements and modifications thereto.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIGS. 1A-1I are block diagrams of the system having at least a client device, a network device and a server for processing data through network according to some embodiments of the present invention.

FIGS. 2A-2J are diagrams illustrating a method for accessing and processing data through network according to some embodiments of the present invention.

FIGS. 3A-3C are block diagrams illustrating a system for processing data received by a networked input device through network according to some embodiments of the present invention.

In accordance with common practice, the various described features are not drawn to scale and are drawn to emphasize features relevant to the present disclosure. Like reference characters denote like elements throughout the figures and text.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, layer or section. Thus, a first element, component, region, part or section discussed below could be termed a second element, component, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

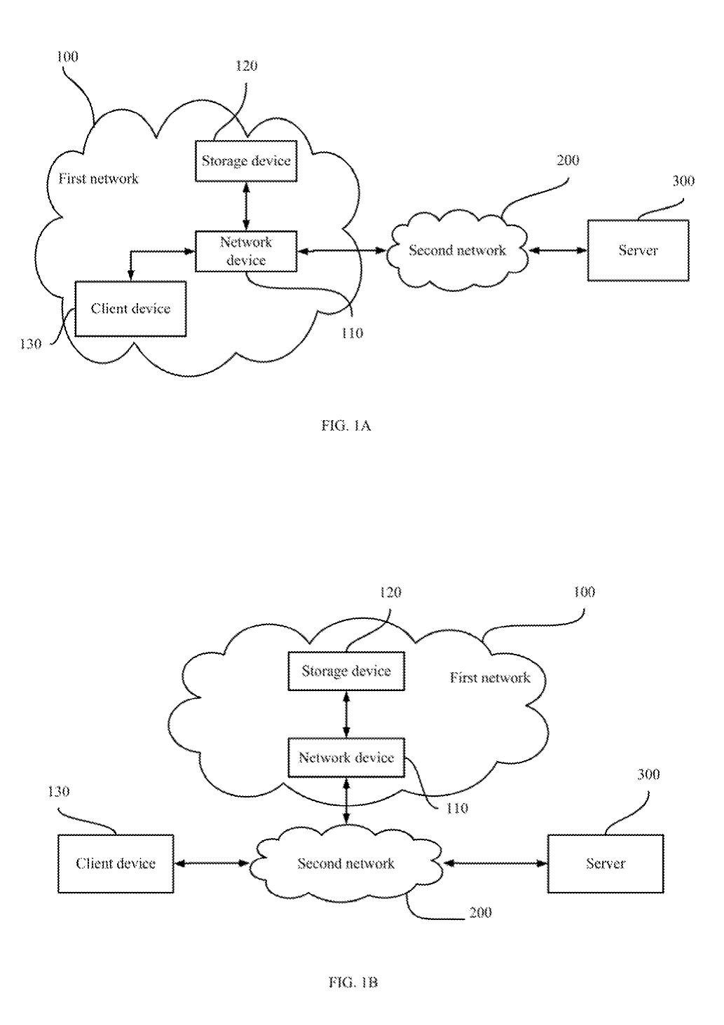

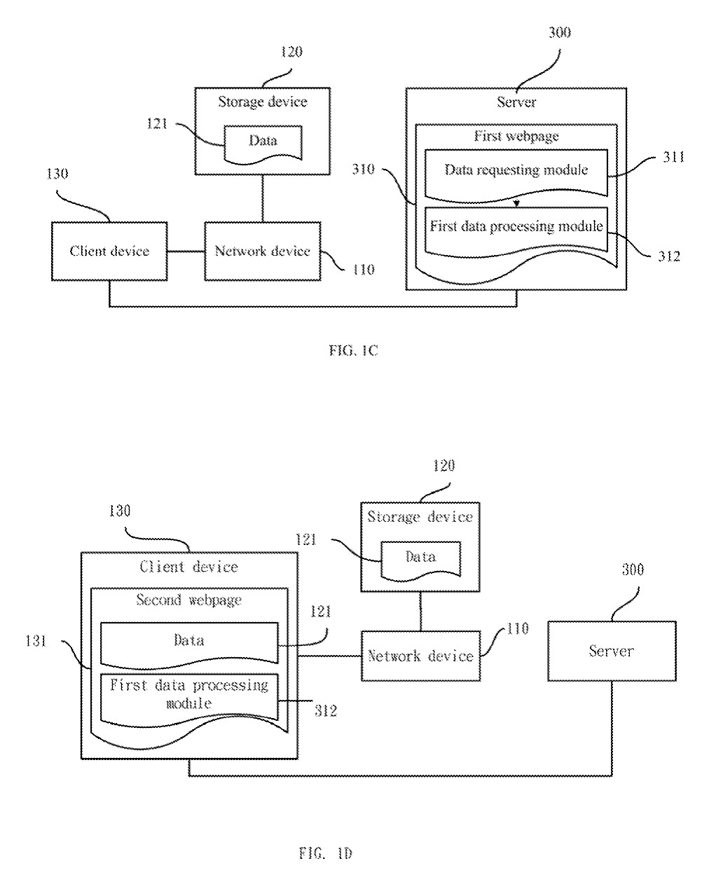

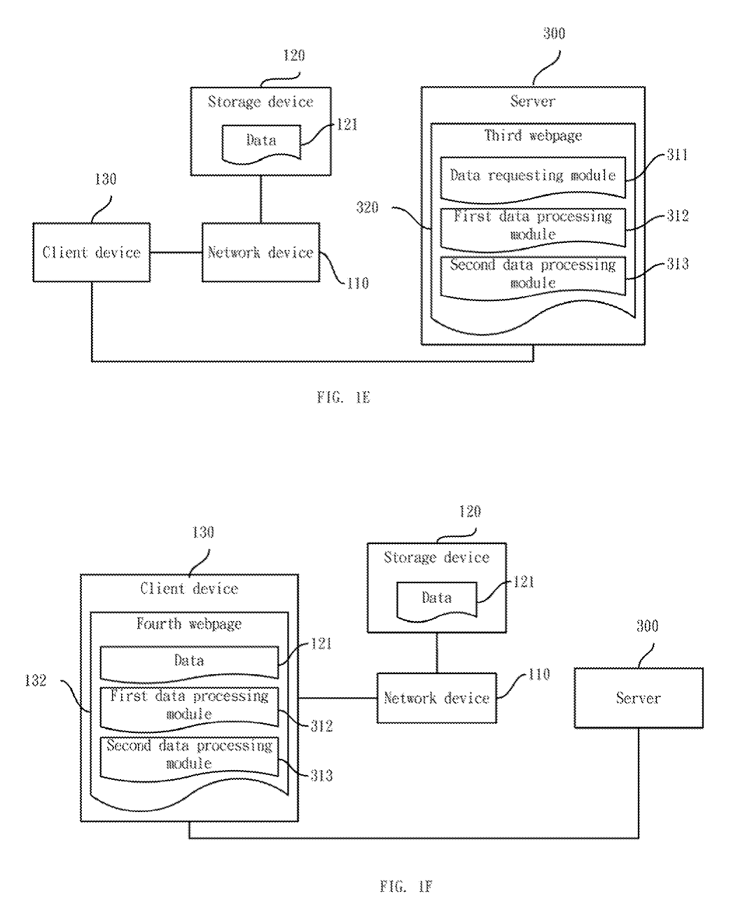

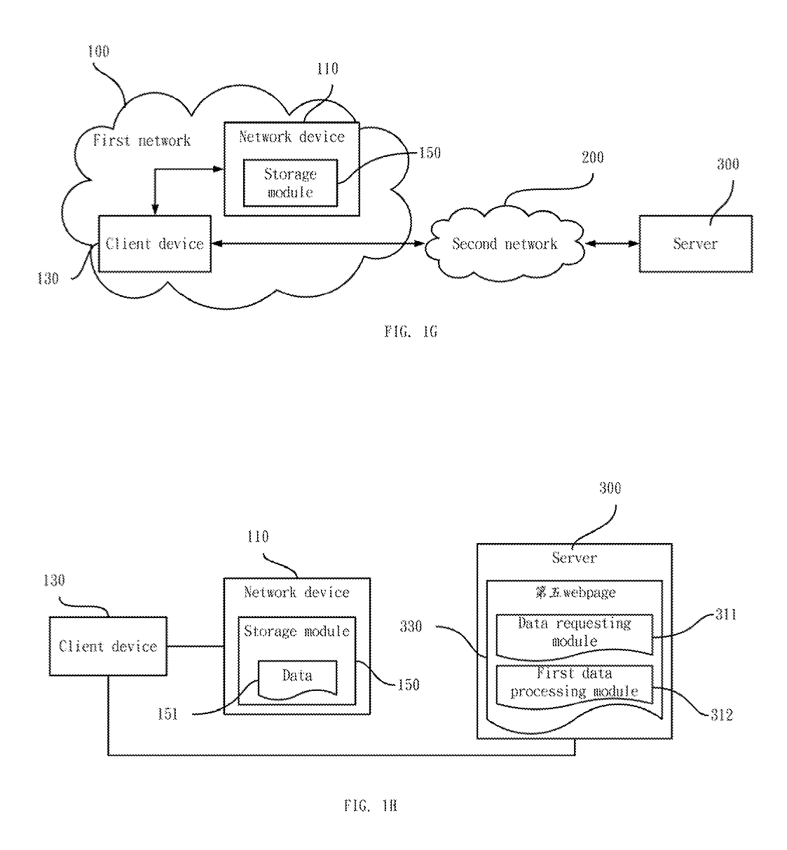

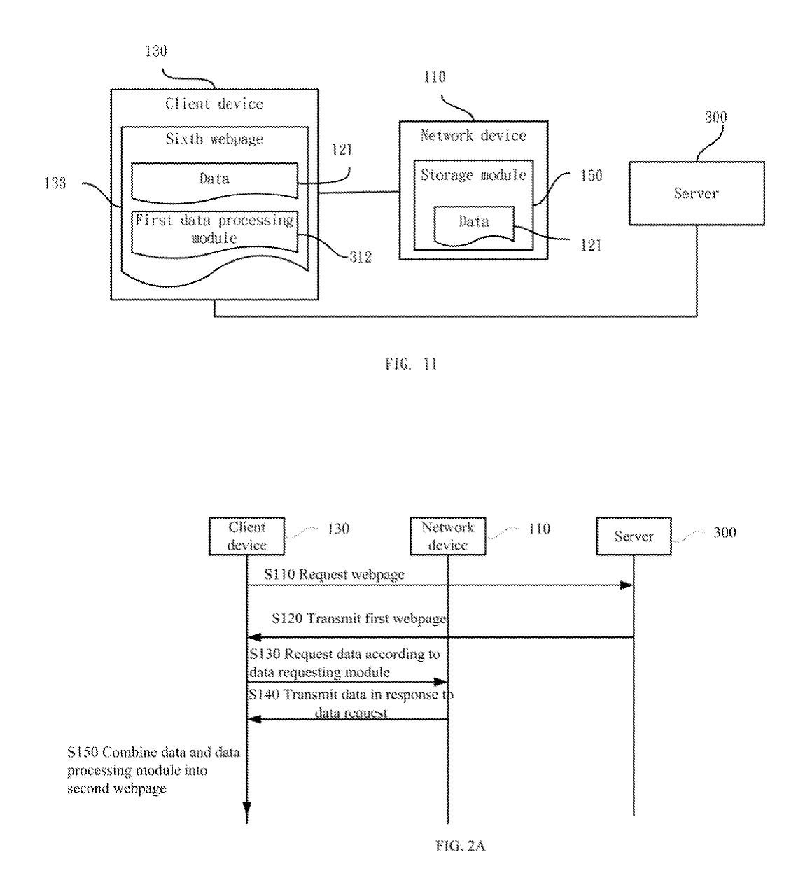

The description will be made as to the embodiments of the present invention in conjunction with the accompanying drawings in FIGS. 1A-3H. Reference will be made to the drawing figures to describe the present invention in detail, wherein depicted elements are not necessarily shown to scale and wherein like or similar elements are designated by same or similar reference numeral through the several views and same or similar terminology. In accordance with the purposes of this invention, as embodied and broadly described herein, this invention,

FIGS. 1A-1I are block diagrams of the system having at least a client device, a network device and a server for processing data through network according to some embodiments of the present invention. Here, the server may provide a data processing module for processing data, and the network device may access the data stored in an internal or external storage device of the network device. Accordingly, the client may use the processing module received from the server to process the data received from the network device.

FIG. 1A is an illustration of one embodiment of a system for processing data through network of the present invention. The network device 110, the storage device 120 and the client device 130 may be in a first network 100. The network device 110 may be connected to a second network 200 and may access the storage device 120 via the first network 100. The storage device 120 is used to store data. The client device 130 may be connected to the network device 100 via the first network 100 and access the second network 200 through the network device 110. Moreover, the client device 130 may receive internet service from the server 300 via the second network 200. Moreover, the client device 130 may access the storage device 120 through the network device 110 in the first network 100, and may process data through the internet service received from the server 300 via the second network 200.

FIG. 1B illustrates another embodiment of the system for processing data through network of the present invention. Here, the network device 110, the storage device 120 may be in the first network 100. The client device 130 may be connected to the first network 100 via the second network 200, and may access the storage device 120 through the network device 110. In addition, the client device may be directly connected to the second network 200, and process data by receiving internet service network device from the server 300 via the second network 200.

It is to be noted that the first network 100 may be a computer network, especially a wired or wireless local area network. The second network 200 may be a local area network, a wide area network, a mobile network or the Internet. In addition, the network device 110 may be a device for connecting the first network 100 and the second network 200, such as a modem, a gateway, a router, a switch, an access point, a hot spot or a femtocell. Moreover, network device 110 may be a device used for other purpose, such as a network-attached storage, a firewall, a work station or a proxy server.

The storage device 120 may be an external flash drive, hard disk or solid state drive of the network device 110. The storage device 120 may also be a network-attached storage connected to the network device 110 in a wired or wireless form. Furthermore, the storage device 120 may be a storage server or a storage area network (SAN) having multiple storage servers. The client device 130 may be a computing device having internet connectivity. For example, a desktop, a laptop, a tablet computer, or handheld devices such as a personal digital assistant (PDA) or a smart phone. The server 300 may be a server cluster or data center having multiple servers.

FIG. 1C illustrates another embodiment of the system for processing data through network of the present invention. Here, the client device 130 may request application server from the server 300, as illustrated in FIGS. 1A and 1B. Accordingly, the server 300 may generate a first webpage 310 to transmit back to the client device 130 for the client device 130 to display. The first webpage 310 may include a data requesting module 311 and a first data processing module 312. The data requesting module 311 may enable the client device 130 to transmit a data request to the network device 110 when the client device 130 executes the first webpage 310. The first data processing module 312 may provide to the client device 130 functions, such as view, modify, store, chare, add, move, copy or delete, according to the format of the data 121.

FIG. 1D illustrates a same embodiment of the system for processing data through network of the present invention as in FIG. 1C. Here, after the client device 130 receives the first webpage 310, the client device 130 may execute the file requesting module 311 to request the data 121 from the network device 110. The network device 110 may accordingly access the data 121 in the storage device 120, copy the data 121, and transmit the data 121 to the client device 130. Thereafter, the client device 130 may combine the data 121 and the first data processing module 312 into a second webpage 131 and display the second webpage 131. As a result, a user may both access the storage device (especially personal storage devices) and use the service provided by the server through network.

Therefore, the invention may provide a system utilizing the storage device 120 for storing data and the server 300 for storing the application services. As a result, the system may support the update of the data and the application services in the storage device 120 and the server 300 respectively so as to provide more flexibility and less complexity for integrating new services into the system.

The file requesting module 311 may include information such as network address of the network device 110, name of the data 121, and the file path of the data 121 in the storage device 120. Further, the file requesting module 311 may include a data requesting command implemented by program languages to enable the client device 130 to transmit a data request to the network device 110 when the client device 130 executes the first webpage 310.

The first data processing module 312 may be a source code embedded into the first webpage 310, or may be in the form of a document referenced by the first webpage 310 and transmitted to the client device 130 along with the first webpage 310. For example, if the data 121 is a photo (such as a JPEG file, a PNG file or a BMP file), the first data processing module 312 may be in the form of JavaScript or ActionScript source code embedded in the first webpage 310. Accordingly, when the first webpage is executed, the client device 130 may perform photo editing functions such as photo viewing, cropping, rotation, brightness adjustment . . . etc. Moreover, after the photo is edited, the client device 130 may perform functions such as store, share, delete, move and copy. On the other hand, the first data processing module 312 may be an application executable file (ex. swf format), and a link to such file may be embedded into the first webpage 310. As a result, when the first webpage 310 is executed, the application will be embedded into the first webpage 310.

Furthermore, the first webpage 310 may be a file coded by a markup language, such as HTML or XML, or other program languages, or necessary information for the presentation of user interfaces and for the application of the client device to generate the aforementioned user interface.

The second webpage 131 may be a file coded by a markup language, such as HTML or XML, or other program languages, and may be an user interface of an application, such as a graphical user interface of a mobile application. In addition, the data 121 and the first data processing module 312 may be a source code embedded into the second webpage 131, or an application executable file and a link to such file may be embedded into the second webpage 131. As a result, when the first webpage 310 is executed, the application will be embedded into the first webpage 310.

FIG. 1E illustrates one embodiment of the system for processing data through network of the present invention. With reference to FIG. 1C, after the client device 130 requests an application service from the server 300, the server 300 generates a third webpage 320 and transmits the third webpage 320 to the client device 130. The third webpage 320 may include the data requesting module 311, the first data processing module 312 and a second data processing module 313. The data requesting module 311 may enable the client device 130 to transmit a data request when the client device executes the third webpage 320. Moreover, the first data processing module 312 and a second data processing module 313 may provide to the client device 130 functions, such as view, modify, store, chare, add, move, copy or delete, according to the format of the data 121.

FIG. 1F illustrates a same embodiment of the system for processing data through network of the present invention as in FIG. 1E. Here, after the client device 130 receives the third webpage 320, the client device 130 may execute the file requesting module 311 to request the data 121 from the network device 110. Moreover, the client device 130 may combine the data 121, the first data processing module 312 and the second data processing module 313 into a fourth webpage 312, and may display the fourth webpage 312. The first data processing module 312 and the second data processing module 313 may provide different functions. For example, in some embodiments, the first data processing module 312 may provide photo editing functions, such as cut, rotate, brightness adjustment . . . etc. On the other hand, the second data processing module 313 may provide data storing functions to store the file edited at the client device 130 by the first data processing module 312 to the storage device 120. Moreover, in some embodiments, the first data processing module 312 may provide video playing function and the second data processing module 313 may provide video sharing function. The second data processing module 313 may share the data in the storage device 120 chosen by a user through the client device 130, such as the data 121, to other servers or other network devices. The first data processing module 312 and the second data processing module 313 may be a source code embedded into the third webpage 320, or a file referenced by the third webpage 320 and transmitted to the client device 130 along with the third webpage 320.

Therefore, the invention may provide a system utilizing the storage device 120 for storing data and the server 300 for storing the application services. As a result, the system may support the update of the data and the application services in the storage device 120 and the server 300 respectively so as to provide more flexibility and less complexity for integrating new services into the system. Moreover, new data processing modules may be provided by the server to the client device without the user updating the client device.

The third webpage 320 may be a file coded by a markup language, such as HTML or XML, or other program languages, or necessary information for the presentation of user interfaces and for the application of the client device to generate the aforementioned user interface.

The fourth webpage 132 may be a file coded by a markup language, such as HTML or XML, or other program languages, and may be an user interface of an application. In addition, the data 12, the first data processing module 312 and the second data processing module 313 may be a source code embedded into the fourth webpage 132, or an application executable file and a link to such file may be embedded into the fourth webpage 132.

FIG. 1G illustrates one embodiment of the system for processing data through network of the present invention. Here, the network device 110 and the client device 130 are in the first network 100. Specifically, the storage device here is the storage module 150, which is embedded in the network device 110. The storage module 150 may be a hard disk or a solid state drive, which may be accessed by the network device 110. In addition, the client device may receive internet service from the server 300 via the second network 200. Moreover, the client device 130 may access the network device 110 in the first network 100, and receive network service from the server 300 via the second network 200 to process data.

FIG. 1H illustrates one embodiment of the system for processing data through network of the present invention. Here, the client device 130 may request application service from the server 300, and the server 300 may correspondingly generate a fifth webpage 330 to be transmitted to the client device 130. The fifth webpage 330 may include the data requesting module 311 and the first data processing module 312. The data requesting module 311 may enable the client device 130 to transmit a data request to the network device 110 when the client device 130 executes the fifth webpage 330. The first data processing module 312 may provide to the client device 130 functions, such as view, modify, store, chare, add, move, copy or delete, according to the format of the data 121.

FIG. 1I illustrates a same embodiment of the system for processing data through network of the present invention as in FIG. 1H. Here, after receiving the fifth webpage 330, the client device 130 may execute the data requesting module 311 to request the data 121 from the network device 110. Accordingly, the network device 110 may access the data 121 in the storage module 150, copy the data 121, and transmit the data 121 to the client device 130. The client device 130 may combine the data 121 and the first data processing module 312 into a sixth webpage 133. The client device 130 may further display the sixth webpage 133.

The fifth webpage 330 may be a file coded by a markup language, such as HTML or XML, or other program languages, or necessary information for the presentation of user interfaces and for the application of the client device to generate the aforementioned user interface.

The sixth webpage 133 may be a file coded by a markup language, such as HTML or XML, or other program languages, and may be an user interface of an application, such as a graphical user interface of a mobile application. In addition, the data 121 and the first data processing module 312 may be a source code embedded into the sixth webpage 133, or an application executable file and a link to such file may be embedded into the sixth webpage 133.

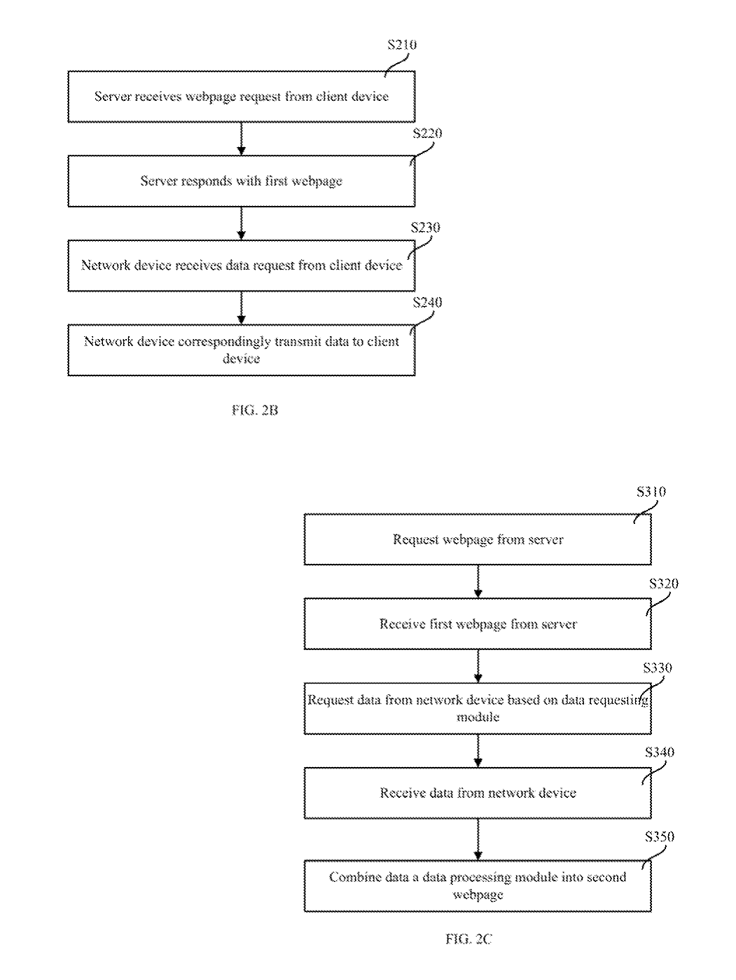

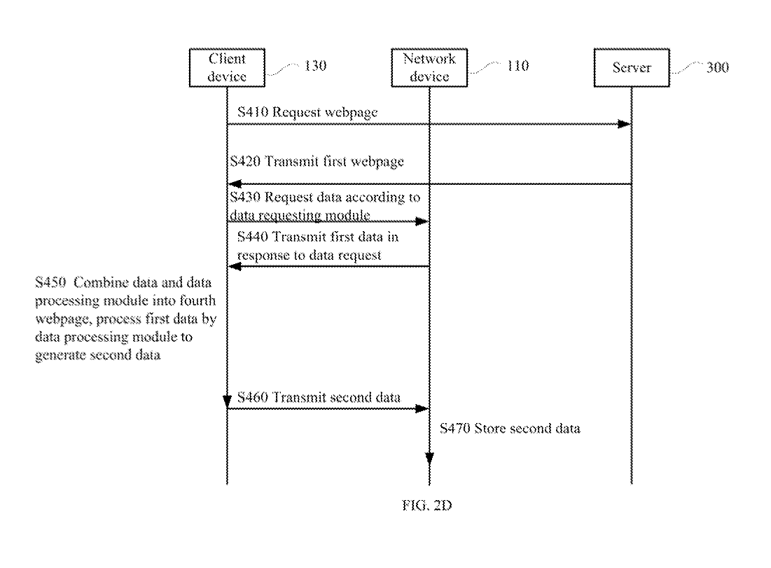

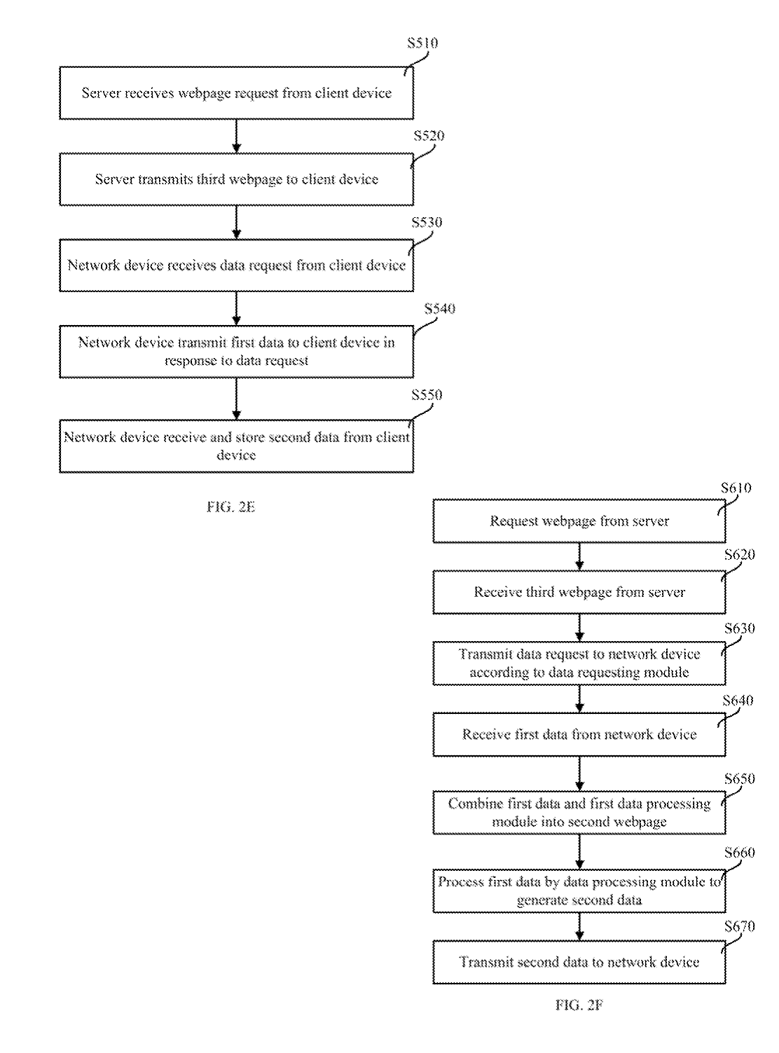

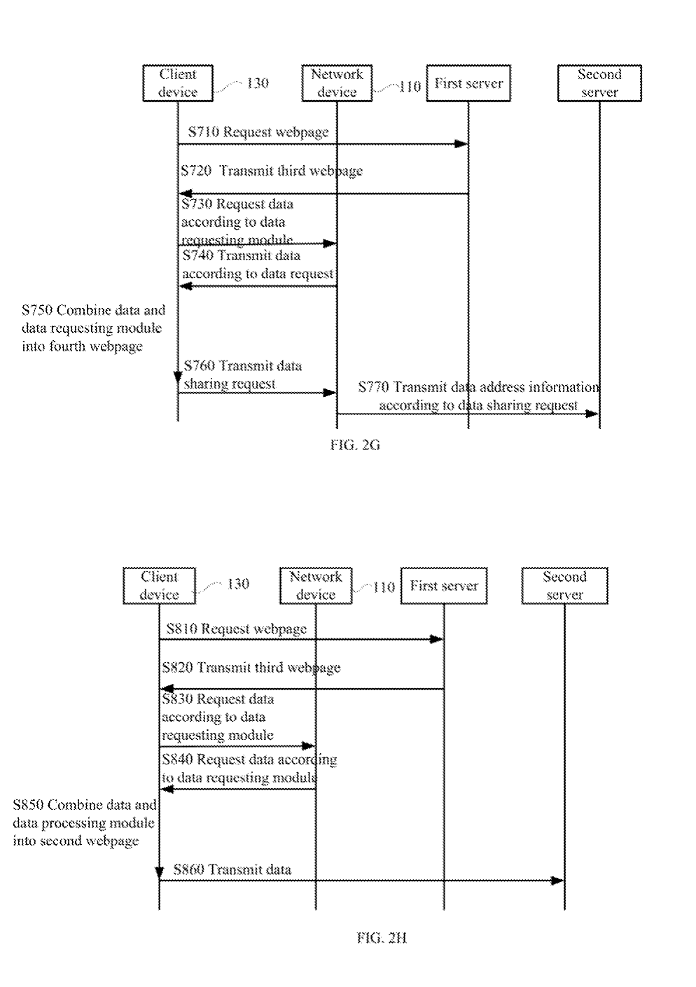

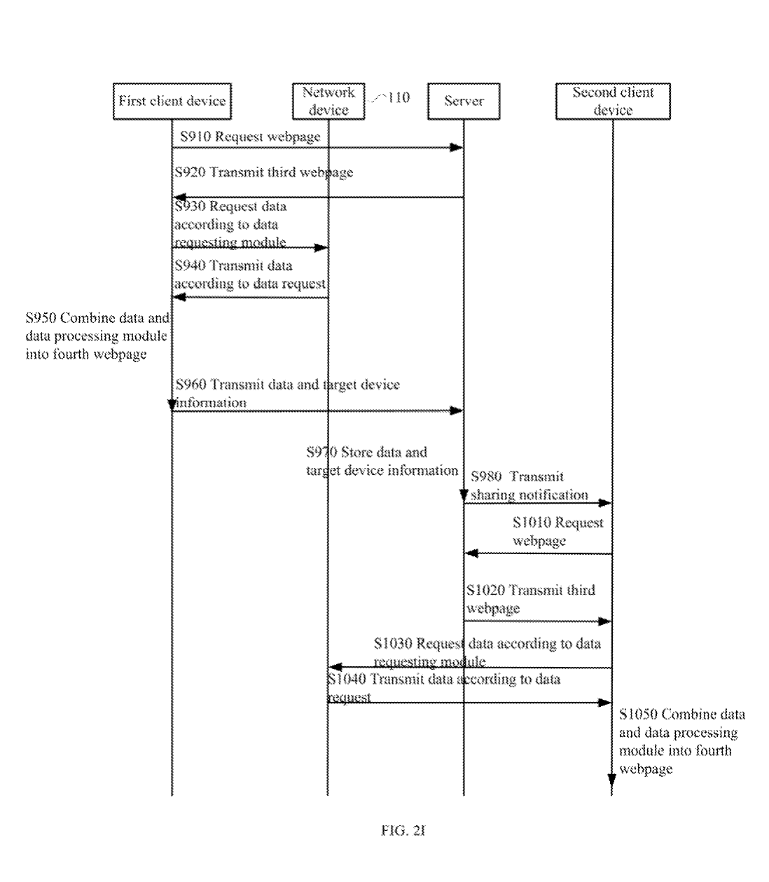

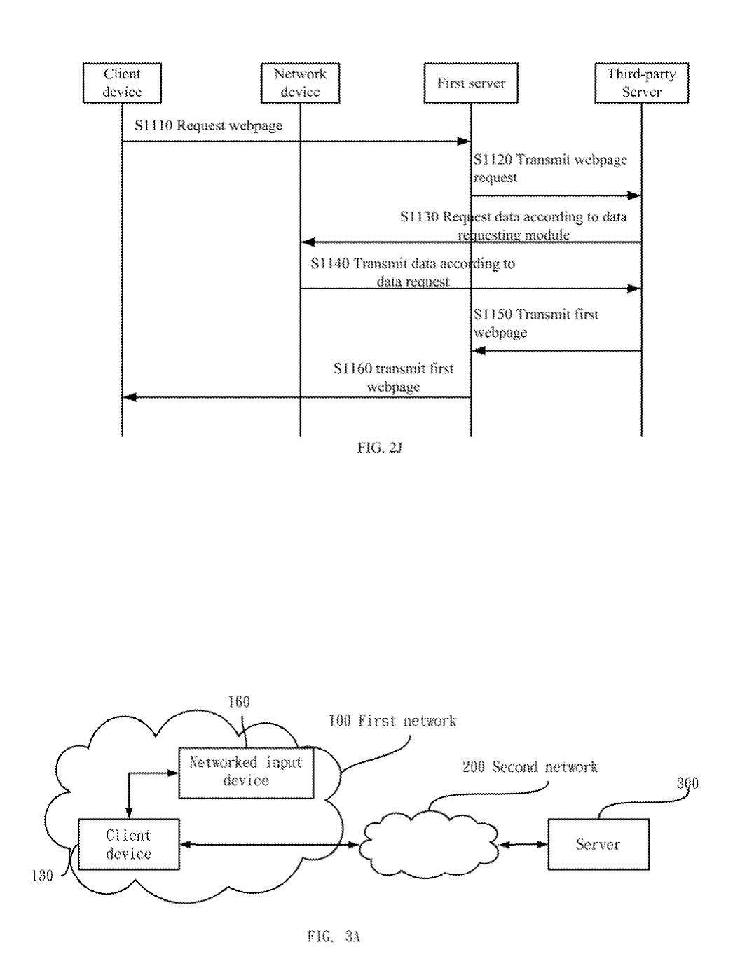

FIGS. 2A-2J are diagrams illustrating a method for accessing and processing data through network according to some embodiments of the present invention.

FIG. 2A illustrates one embodiment of the method for accessing data through network of the present invention. Specifically, the present embodiment may be implemented in the system disclosed in FIGS. 1C and 1D. In step S110, a user at the client device 130 may transmit a webpage request to the server 300. In step S120, the serve 300 corresponding to the webpage request transmits to the client device 130 a first webpage 310, which includes a data requesting module and a data processing module. In step S130, when the client device 130 executes the first webpage 310, the data requesting module is also executed. As a result, according to the data address information in the data requesting module, the client device 130 transmits a data request to the network device 110, In step S140, the network device 110, in response to the data request, acquires data from the storage device 102, as illustrated in FIG. 1D, and combine the data and the data processing module into a second webpage 131. As a result, a user may both access the storage device (especially personal storage devices) and use the service provided by the server through network.

FIG. 2B illustrates one embodiment of the method for accessing data through network of the present invention. Specifically, the flowchart illustrates the data accessing process between the server and the network device in FIG. 2A. In step S210, the server 300 receives a webpage request from the client device 130. In step S220, the server 300 correspondingly transmits the first webpage 310, which has the data requesting module and the data processing module. When the first webpage 310 is executed by the client device 130, the data requesting module may enable the client device 130 to request data from the network device 110. In step S230, the network device 110 receives a data request from the client device 130. In step S240, the network device 110 correspondingly accesses the data in the storage device 120 and transmits the data to the client device 130.

FIG. 2C illustrates one embodiment of the method for accessing data through network of the present invention. Specifically, the flowchart illustrates the method implemented in the client device as in FIG. 2A. In step S310, a webpage request is transmitted to the server 300 from the client device 130. In some embodiments, the client device 130 receives an input from a user to decide which webpage of data processing function to request. In step S320, the client device 130 receives the first webpage 310, which has the data requesting module and the data processing module. IN step S330, the data requesting module is executed by the client device 130, which correspondingly transmits a data request to the network device 110 according to the data address information in the data requesting module. In step S340, the client device 130 receives data transmitted from the network device 110. In some embodiments, step S350 may be performed, and the data and the data processing module may be combined into the second webpage 131 by the client device 130. Furthermore, the client device 130 may display the second webpage 131 or a user interface generated according to the second webpage 131. In addition, the client device 130 may process data according to the user's input to execute the data processing module. As a result, a user may both access the storage device (especially personal storage devices) and use the service provided by the server through network.

FIG. 2D illustrates one embodiment of the method for accessing data through network of the present invention. Specifically, the present embodiment may be implemented in the system disclosed in FIGS. 1E and 1F. In step S410, a user at the client device 130 transmits a webpage request to the server 300. In step S420, the server 300, in response to the webpage request, transmits to the client device 130 a third webpage 311, which has the data requesting module and the data processing module. In step S430, when the client device 130 executes the third webpage 311, the data requesting module is also executed to enable the client device 130 to transmit a data request to the network device 110. In step S440, the network device 110 correspondingly transmits a first data to the client device 130. In step S450, the client device 130 may combine the first data and the data processing module into a fourth webpage 132, and process the first data by the data processing module to generate a second data. In step S460, the client device 130 transmits the second data to the network device 110, and requests the network device 110 to store the second data. In step S470, the network device 110 receives the second data and the data store request, and accordingly store the second data. Moreover, the second data may replace the first data in the storage device. As a result, the data on the storage device may be processed through network, and the processed data may be stored and replace the old data.

In some embodiments, the client device 130 may execute the fourth webpage 132 through a web browser, and may execute the data processing module to process the first data to generate the second data after receiving an input from the user. For example, the first data may be a photo file, and the web browser executes the data processing module to rotate the photo and generate the second data of a rotated photo. In other embodiments, the third webpage 320 may include a data storing module, which may be combined with the first data and the data processing module into the fourth webpage 132 in step S460. The client device 130 may execute the data storing module through the web browser to enable the client device 130 to transmit the second data and a data storing request to the network device 110. Alternatively, the client device 130 may include applications having the data storing module, and may combine the first data, the data processing module and the data storing module into the fourth webpage 132. The application may execute the fourth webpage 132, and then execute the data storing module after the user inputs a command to enable the client device 130 to transmit the second data and the data storing request to the network device 110.

FIG. 2E illustrates one embodiment of the method for accessing data through network of the present invention. Specifically, the flowchart illustrates the data accessing process between the server and the network device in FIG. 2D. In steps S510-S540, the server 300 and the network device 110 may receive a request from the client device 130 and correspondingly transmit the third webpage 320 and the first data respectively. The third webpage 320 includes the data requesting module, the data processing module. Based on the data requesting module, the client device 130 requests the first data from the network device 110. In step S550, the network device 110 receives the second data, which is generated by the client device 130 processing the first data using the data processing module. The third webpage 320 may include the data storing module 150, which may enable the client device 130 to transmit to the network device 110 the second data and a data storing request after receiving a user input. In addition, the network device 110 may store the second data in the storage module 150, as illustrated in FIG. 2D.

FIG. 2F illustrates one embodiment of the method for accessing data through network of the present invention. Specifically, the flowchart illustrates the method implemented in the client device as in FIG. 2D. In steps S610-S650, the client device 130 may request and receive the third webpage 320 from the server 300, request and receive the first data from the network device 110 according to the data requesting module in the third webpage 320, and combine the first data and the data processing module into the fourth webpage 132. In step S660, the client device 130 may execute the data processing module to process the first data so as to generate the second data. In step S670, the client device 130 may transmit the second data to the network device 110, and request the network device 110 to store the second data. The third webpage 320 may include a data processing module to enable the client device 130 to perform step S660 after receiving a user input, and a data storing module to enable the client device 130 to perform step S670 after receiving a user input.

FIG. 2G illustrates one embodiment of the method for accessing and sharing data through network of the present invention. In steps S710-S750, as illustrated in FIG. 2D, the client device 130 may receive the third webpage 320 from a first server, and request and receive data from the network device 100 according to the data in the third webpage 320. Moreover, the client device 130 may combine the data and the data processing module into the fourth webpage 132. In step S760, the client device 130 may transmit the data sharing request to the network device 110. In step S770, the network device 110 may transmit data address information to the second server according to the data sharing request. As a result, the data on the storage device may be shared via network.

In some embodiments, the data processing module may provide data sharing function to enable the client device 130 to perform step S760 after receiving a user input. In addition, the data sharing request may include the information of the data (ex. file name), and the information of the target device (ex. target device name or target device address). Moreover, the network device 110 may transmit the data address information to the target device, which may include the second server, according to the data sharing request. The second server may be an electronic mail server or a webpage server for running personal websites such as facebook or twitter. Such webpage server may further generate a webpage having the data address information at the website. For example, the network device 110 may share the data address information and the target device information to the facebook website, and the facebook website may accordingly update the login page of the target device based on the target device information, and the updated login page may include the data address information.

In another embodiment, the network device 110 may generate an internet address, such as an URL or IP address, in step S770. Such internet address may be transmitted to the second server, and may include the data link information or commands for accessing the data at the network device 110. The network device 110 may transmit the internet address to the second server. Moreover, in step S770, the network device 110 may transmit the data sharing request and the data address information to the first server so that the first server may accordingly generate the aforementioned internet address and transmit to the second server. Furthermore, the network device 110 may transmit the data to the second server directly. Alternatively, the data may be transmitted to the first server, and then from the first server to the second server.

FIG. 2H illustrates one embodiment of the method for accessing and sharing data through network of the present invention. In steps S810-S850, as illustrated in FIG. 2G, the client device 130 may request and receive the data and the data processing module respectively, and combine the data and the data processing module into the fourth webpage 132. In step S860, the client device 130 may transmit the data to the second server. Particularly, the data processing module may provide data sharing function, as illustrated in FIG. 2G, to enable the client device 130 to perform step S860 or transmit the data to the first server, after receiving a user input. Specifically, the data transmitted to the first server may be transmitted to the second server by the first server.

FIG. 2I illustrates one embodiment of the method for accessing and sharing data through network of the present invention. In steps S910-S950, the first client device may request and receive the file and the data processing module respectively, and combined the data and the data processing module into the third webpage 320, as illustrated in FIG. 2H. In step S960, the client device 130 may transmit the data information and the target device information to the server 300. The data information may include data name or data path, and the target device information may include target device name and target device internet address. Moreover, the target device information may correspond to the second client device that the target device uses. In step S970, the server 300 may receive and store the data information and the target device information. In step S980, the server 300 may transmit a sharing notification to the second client device according to the target device information and the data information. The sharing notification may enable the second client device to request a webpage from the server 300. In steps S1010-S1050, the second client device may request and receive the data and the data processing module, as illustrated in steps S910-S950, and combine the data and the data processing module into the fourth webpage. As a result, the data may be shared with the second client device so the second client device may access the data.

In some embodiments, the server 300 may generate an internet address, such as URP or IP address, in step S980. The internet address corresponds to the command for requesting data from the server 300 and may enable the aforementioned sharing notification to include the internet address, which may correspond to a command for requesting to access the data in the server 300. After receiving the sharing notification, the second client device may perform step S1010 according to the internet address.

In other embodiments, the target device information in step S960 may include the electronic mail address of the target device. Moreover, the server 300 may transmit the sharing notification to the electronic mail box (electronic mail server) of the target device by electronic mail in step S980. The electronic mail may include the internet address that corresponds to the command for requesting the data from the server 300. Alternatively, the data may be the attachment of the electronic mail and transmitted to the electronic mail box of the target device. As a result, the data may be shared with the second client device so the second client device may access the data.

FIG. 2J illustrates one embodiment of the method for accessing and sharing data through network of the present invention. Specifically, the data processing function/module may be provided by a third-party server supplying third-party applications. The third-party server, such as the Google Document server, may receive data, process data, and provide data display or edit in a webpage format. In step S1110, the client device 130 may request a webpage from the first server. In step S1120, the first server may transmit to the third-party server a webpage request, which include the data requesting module. The data requesting module may enable the third-party server to transmit to the network device a data request when the webpage is requested to be executed. In step S1130, the third-party server may respond to the webpage request and execute the data requesting module in the webpage. Accordingly, the third-party server may request data from the network device. In step S1140, the network device responds to the data request and transmits the data to the third-party server. In step S1150, the third-party server receives the data and combines the data and the data processing module into the first webpage. Thereafter, the third-party server may transmit the first webpage to the first server in response to the webpage request from the first server. In step S1160, in response to the webpage request received from the client device, the first server transmits the first webpage to the client device. The client device may further display the first webpage. As a result, a user may both access the storage device (especially personal storage devices) and use the application service provided by the third-party server to process data.

In some embodiments, the data requesting module may include the internet address of the network device, the data name, or the data address information. Further, the data requesting module may include an data requesting command implemented by program language to enable the third-party server to perform step S1130. In other embodiments, the data and the data processing module in step S1150 may be a source code implemented by program language, and may be embedded into the first webpage. Alternatively, the data and the data processing module may be a file, with the link thereof embedded into the first webpage.

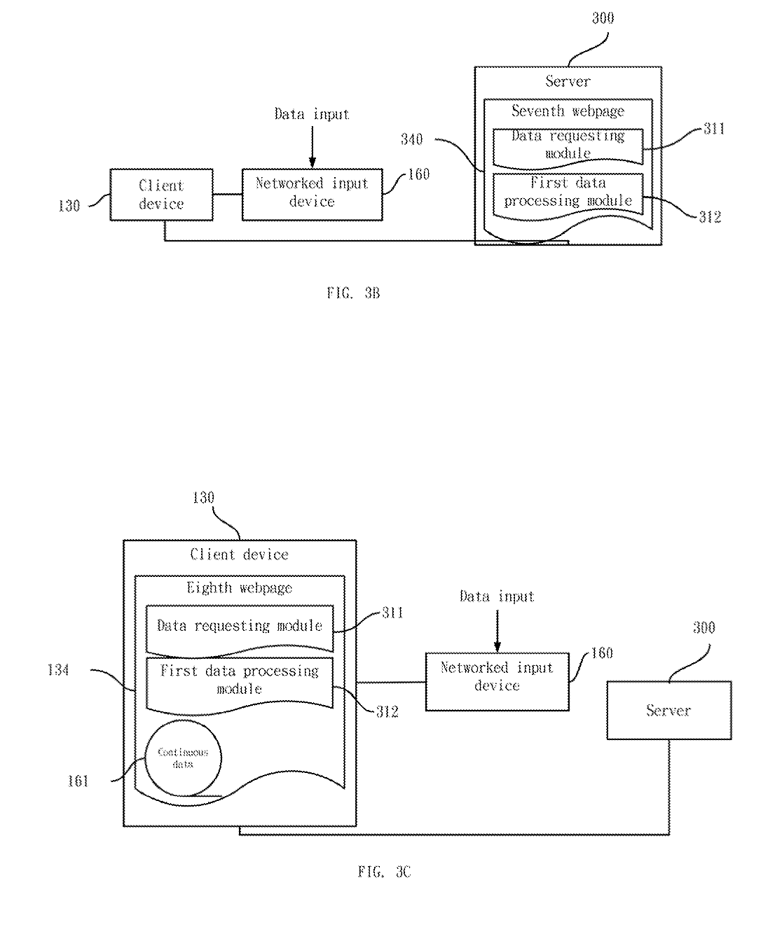

FIGS. 3A-3C are block diagrams illustrating a system for processing data received by a networked input device through network according to some embodiments of the present invention. The system may include a networked input device and a server. The server may provide data processing module for data processing, and the networked input device may receive continuous data input in a wired or wireless form. The system is configured to enable the client device to execute the data processing module from the server to processing the data received from the networked input device.

FIG. 3A illustrates one embodiment of the system for processing data through network of the present invention. The client device 130 and the networked input device 160 may be in the first network 100. The client device 130 may receive data through the networked input device, and may process data by receiving internet service from the server 300 through the second network 200. In some embodiments, the networked input device 160 may receive data continuously wired or wirelessly. For example, the networked input device 160 may be a television or a television setup box, which receives cable television signals through a cable or a satellite signal wirelessly. In another example, the networked input device 160 may be a radio, which receives radio content wirelessly.

FIG. 3B illustrates one embodiment of the system for processing data through network of the present invention. Here, the client device 130 may request application server from the server 300, which accordingly generates a seventh webpage 340. The seventh webpage 340 may include the data requesting module 311 and the first data processing module 312. The data requesting module 311 may enable the client device 130 to transmit a data request to the networked input device 160 when the client device 130 executes the seventh webpage 340. The first data processing module 312 may provide to the client device 130 functions, such as view, modify, store, chare, add, move, copy or delete, according to the format of the data.

In some embodiments, the data requesting module 311 may include the internet address of the networked input device 160, and may include the data requesting command implemented by program language. In addition, the data requesting command may include information related to the data request, such as the duration of the data request, the form of the source signal (ex. wired or wireless), or the format of the signal (ex. television signal or radio signal). For example, if the networked input device 160 is a cable television, the data input in FIG. 21 may be the content of the cable television channel. Accordingly, the data requesting module 311 may be embedded in the seventh webpage 340 in the form a source code, such as JaveScript or ActionScript. Therefore, when the webpage 340 is being executed, the client device 130 may request specific cable television content from the networked input device 160 and simultaneously receive the cable television content. It is to be noted that the first data processing module 312 may be a source code embedded into the seventh webpage 340, or may be in the form of a document referenced by the seventh webpage 340 and transmitted to the client device 130 along with the seventh webpage 340. Furthermore, the seventh webpage 340 may be a file coded by a markup language, such as HTML or XML, or other program languages, or necessary information for the presentation of user interfaces and for the application of the client device to generate the aforementioned user interface.

FIG. 3C illustrates a same embodiment of the system for processing data through network of the present invention as in FIG. 3B. Here, after the client device receives and executes the seventh webpage 370, the first data processing module 312 may request data from the networked input device 160. The networked input device 160 may correspondingly respond to the request and transmit continuous data 141 to the client device 130. The client device 130 may further combine the continuous data 161 and the first data processing module 312 into an eighth webpage 134, and the client device 130 may display such eight webpage 134. In one embodiment, the eighth webpage 134 may be a user interface of an application.

In some embodiments, the continuous data 161 and the first data processing module 342 may be embedded into the eighth webpage 134 in the form of a source code. Alternatively, the continuous data 161 and the first data processing module 342 may be in the form of a file, which the link thereof is embedded into the eighth webpage 134. For example, if the networked input device 160 is an internet television, the continuous data 161 may be the television channel content. The first data processing module 312 may be embedded into the eighth webpage 134 in the form of source code programmed by program language, including but not limited to JavaScript or ActionScript. Therefore, when the eighth webpage 134 is executed, functions such as channel selection may be provided. Furthermore, functions for recorded contents, such as storing, sharing, adding, moving, copying or deleting, may be provided. If the internet television is continuously receiving content in a standby mode, the system for processing data through network of the present invention provides supplying new functions without updating the firmware of the television. In addition, a client device may receive and play the content of the internet television even if the client device and the internet television is in a different location.

In some embodiments, the continuous data 161 may be transmitted to the client device 130 by the internet protocol related to the data format. Such protocols may include real time transmission protocol such as RTMP. Alternatively, the client device 130 may set to request data from the networked input device periodically. For example, the client device 130 may request M-JPEG files from the networked input device after every predetermined interval.

Previous descriptions are only embodiments of the present invention and are not intended to limit the scope of the present invention. Many variations and modifications according to the claims and specification of the disclosure are still within the scope of the claimed invention. In addition, each of the embodiments and claims does not have to achieve all the advantages or characteristics disclosed. Moreover, the abstract and the title only serve to facilitate searching patent documents and are not intended in any way to limit the scope of the claimed invention.

What is claimed is:

1. A system for processing data in a storage device through network, the system comprising:
a first server configured to receive a webpage request from a first client device and correspondingly transmit a first webpage to the first client device; and
a network device communicative to a storage device having a first data, wherein the network device is configured to receive a data request from the first client device and correspondingly access the storage device to retrieve and transmit the first data to the first client device,
wherein the first webpage comprises a data requesting module and a data processing module, the data requesting module for enabling the first client device to request the first data from the network device and the data processing module for processing the first data.

2. The system according to claim 1, wherein the storage device, the network device and the first client device are in a first network, and the server is in a second network, wherein the first client device requests the first data from the network device through the first network.

3. The system according to claim 1, wherein the storage device and the network device are in a first network, and the server is in a second network, wherein the first client device requests the first data from the network device through the second network.

4. A method for processing data through network implemented in a server, the method comprises:
receiving from a first client device a webpage request, and correspondingly transmit a first webpage to the first client device,
wherein the first webpage comprises a data requesting module and a data processing module, the data requesting module for enabling the first client device to request a first data from a network device and the data processing module for processing the first data.

5. The method according to claim 4, wherein the first webpage further comprises a data storage module for enabling the first client device to transmit a second data to the network device, wherein the second data is generated by the data processing module processing the first data.

6. The method according to claim 4, wherein the data processing module enables the first client device to transmit a data share request to the network device, wherein the data share request enables the network device to transmit the first data or an address thereof to a second server or a second client device.

7. The method according to claim 4, wherein the data processing module enables the first client device to transmit the first data or an address thereof to a second server or a second client device.

8. The method according to claim 4, wherein the network device is in a first network and the first server is in a second network.

9. The method according to claim 8, wherein the first client device is in the first network, wherein the first client device requests the first data from the network device through the first network.

10. The method according to claim 8, wherein the first client device requests the first data from the network device through the second network.

11. A method for processing data thought network implemented in a network device, the method comprises:
transmitting to a first server a webpage request and correspondingly receiving from the first server a first webpage, wherein the first webpage comprises a data requesting module and a data processing module, the data processing module for processing a first data; and
requesting a network device based on the data requesting module and correspondingly receiving the first data from the network device.

12. The method according to claim 11, further comprises:
generating a second webpage having the first data and the data processing module.

13. The method according to claim 11, further comprises:
generating a second data by the data processing module processing the first data; and
transmitting the second data to the network device.

14. The method according to claim 11, further comprises:
transmitting a data share request to the network device, wherein the data share request enables the network device to transmit the first data or an address thereof to a second server or a second client device.

15. The method according to claim 11, further comprises:
transmitting the first data or an address thereof to a second server or a second client device.

16. The method according to claim 11, wherein the network device is in a first network and the first server is in a second network.

17. The method according to claim 16, wherein the first client device is in the first network, wherein the first client device requests the first data from the network device through the first network.

18. The method according to claim 16, wherein the first client device requests the first data from the network device through the second network.

19. A system for processing data received by a networked input device through network, the system comprising:
a server configured to receive a webpage request from a client device and correspondingly transmit a webpage to the client device; and
a networked input device configured to receive a data request from the client device and correspondingly respond to the data request by receiving a data in a signal form and transmitting the data to the client device,
wherein the webpage comprises a data requesting module and a data processing module, the data requesting module for enabling the client device to request the data from the networked input device, and the data processing module for processing the data.
